(19) United States
(12) Patent Application Publication
(10) Pub. No.: US 2012/0246066 A1
(43) Pub. Date: Sep. 27, 2012

(54) SYSTEM AND METHOD FOR COLLABORATIVE COMMERCE ACROSS A NETWORK

(76) Inventors: Ronald Andrew Rice, Issaquah, WA (US); Carrie Kim, Seattle, WA (US)

(21) Appl. No.: 13/426,542

(22) Filed: Mar. 21, 2012

Related U.S. Application Data
(60) Provisional application No. 61/454,580, filed on Mar. 21, 2011.

(51) Int. Cl. G06Q 20/08

(52) U.S. Cl. 705/39

(57) ABSTRACT

A system and method for facilitating commerce on a network, such as the Internet, by a group of entities that wishes to collectively sell a good or service whereby the payment for the good or service can be automatically divided between the payment destinations for each of the recipients. The plurality of recipients can use a recipient interface to create predetermined payment divvy for payments made, such as those for the goods or services, such that a computer system directs payments to the plurality of recipients based upon the predetermined payment divvy upon receipt of revenue.

### CROSS-REFERENCE TO RELATED APPLICATION

This application is based on and claims the benefit of priority of U.S. Provisional Patent Application Ser. No. 61/454,580, filed on Mar. 21, 2011, the entirety of which is incorporated herein by this reference.

### BACKGROUND

1. Field of the Invention

The present disclosure generally relates to networked computer systems. More particularly, the present disclosure relates to a system and method that allows collaborative commerce by parties desiring to jointly sell a good or service across a network, such as the Internet, and divide the revenue therefrom.

2. Description of the Related Art

There many shopping and commerce websites that exist on the Internet. They allow buyers to peruse catalogs and other descriptions of goods and services, and then allows the buyer to pay for the good or service, typically through an electronic payment transaction via either credit card or bank account. Then the good or service is transferred to the buyer, either physically through the post, or electronically downloaded to a client computer of the buyer. The back end of the payment transaction, e.g. how the money is paid out, to whom, and in what percentages is typically transparent to the buyer at the time of purchase.

The sellers of the goods and services to the buyer are either single entities that have title to and control the goods or services being sold, or can be in a joint venture or some other legal relationship. It is also common for sellers on the Internet to have “flow-through” sales where the sales payment transaction actually occurs on a computer system separate from that of the seller. In some instances, the entire sales transaction may occur on the computer system of a third party with the seller website merely being the display of the information of the transaction.

However, when joint entities are present who desire to collectively sell a good or service, the sellers typically need to form some type of contractual or legal relationship that has tax and liability consequences from the sales. Moreover, the payment arrangement of revenue to the joint sellers from the sales can be complicated and required a trusted relationship if the parties are to be paid in sequence, e.g. a host website gets paid first, then sends payment to the actual seller of the good or service. Thus, the creation and operation of a joint sales relationship for parties desiring to collectively sell a good or service on the Internet can be very problematic, and it is to this issue that the present system and method are primarily directed.

### SUMMARY OF THE DISCLOSURE

The following is a description of a system, process and technology (the “System”), that facilitates a collaborative process of selling goods or services by providing a mechanism whereby multiple parties (each a “User”) can, together, sell a jointly created or provided product or service, receive payment for that product or service through a single designated payee account (a “Share Group”), and then have that payment distributed, based upon pre-determined percentages, to payment destinations (individually each a “Divvy” and in plural “Divvies”) where each Divvy is specified by a User. In addition, the System's functionality can be applied to non-collaborative scenarios where a User desires to have revenues received by the User be distributed to multiple Divvies on a percentage basis.

The System can be implemented as a self-contained service, as a payment service for a third-party's website, application, widget or other digital property (each a “Digital Property”) or directly within a Digital Property's payment functionality. The System and method can be implemented on the Internet, or any public or private network.

One benefit of the System is that it provides a simplified mechanism for the distribution to multiple parties of revenues from products and services without the need for additional and potentially complicated legal, accounting and tax structures. It also provides a simplified way for revenues to be shared by different individuals and/or entities on a product by product or service by service basis.

Briefly described, in one embodiment, the present disclosure describes a system for facilitating distribution of revenue across a network to a collective group of entities that includes at least one computer system that is accessible by at least one buyer across a network, with the computer system selectively providing a recipient interface that is displayable to at least one of a plurality of recipients wherein the plurality of recipients can sell a good or service. The recipients interface further allows the plurality of recipients to create a predetermined revenue distribution scheme for payments made by such that the computer system can distribute revenues to Divvies specified by the plurality of recipients based upon the predetermined revenue distribution scheme.

In one embodiment, described herein is a method for facilitating distribution of revenue across a network to a collective group of entities, that includes the steps of selectively providing a recipient interface that is displayable to at least one of a plurality of recipients wherein the plurality of recipients can designate a plurality of payment destinations for divvying of revenue received. The method then includes the steps of allowing the plurality of recipients to create a predetermined revenue distribution scheme for payments made plurality of recipients, and directing payments to Divvies specified by the plurality of recipients based upon the predetermined revenue distribution scheme.

The System and method can have a share group account, such as a bank account, created by the System such that payments for the sales of the goods or services can be made to the shared group account, and then paid out in the predetermined payment scheme. Alternately, one of the sellers can provide either account information that could be the share group account, or direct the System to another payment system, such as a third party website or payment infrastructure, that can serve to divvy out payments to the plurality of sellers under direction from the System.

The System and method can be embodied to have the payment structure to the sellers altered to include hold-backs of monies (each a “Hold-Back”) that are to be funded and paid before distributions of revenues are made to Divvies, a specific order of fixed amount payments being made such as priority of payments (each a “Priority Divvy”). Priority Divvies can also include fixed amount payments being made to other third parties from the buyer payments prior to distribution of revenues to Divvies.

Other embodiments, elements, and methodologies of facilitating commerce across a network will be described in the Detailed Description below along with accompanying Drawings.

### BRIEF DESCRIPTION OF THE DRAWINGS

FIG. 1 is a representative diagram of a client communicating directly with system servers across the Internet.

FIG. 2 is a representative diagram of a client communicating to a third-party website that then communicates with system servers for payment transaction processing.

FIG. 3 is a representative diagram of a client communicating with a third-party website that then communicates with system servers for payment transaction processing.

FIG. 4 is a flow diagram of one embodiment of general system operation.

FIG. 5 is a flow diagram of an alternative embodiment of system operation.

FIG. 6 is a flow diagram of one embodiment of a Hold-Back implemented in the System.

FIG. 7 is a flow diagram of one embodiment of a Priority Divvy implemented in the System.

FIG. 8 is a representative diagram of the association of a Share Group to one or more products or services.

FIG. 9 is a block diagram of one embodiment of the System acting as a payment processor for a Digital Property and then distributing payment related revenues directly to a Share Group.

FIG. 10 is a block diagram of one embodiment of the direct implementation of the flow of revenues from a payment processer to the System via Automated Clearing House (“ACH”) payment transfer where the System directly interfaces with the ACH system for the receipt of payment related revenues and directly distributes revenues received by the System to the Divvies specified by the Share Group to which the revenues are attributed.

FIG. 11 is a block diagram of one embodiment of a pass-through implementation of the flow of revenues from a payment processer via ACH payment transfer to accounts maintained by a third-party banking system with which the System has been integrated and where the System sends payment instructions to and receives account related information from the third-party banking system for the distribution to Divvies of funds received by an account in the third-party banking system that the System associates with a Share Group.

FIG. 12 is a block diagram of one embodiment of the System implemented within a Digital Property without a Share Group.

FIG. 13 is a block diagram of one embodiment of the System implemented within a Digital Property with a Share Group.

FIG. 14 is a block diagram of one embodiment of the System having direct implementation of hold backs and Priority Divvies where payment is made directly by the System through a bank account associated with the System and not individual Share Groups.

FIG. 15 is a block diagram of one embodiment of the System having pass-through implementation of hold backs and Priority Divvies with a Share Group-associated bank account.

### DETAILED DESCRIPTION

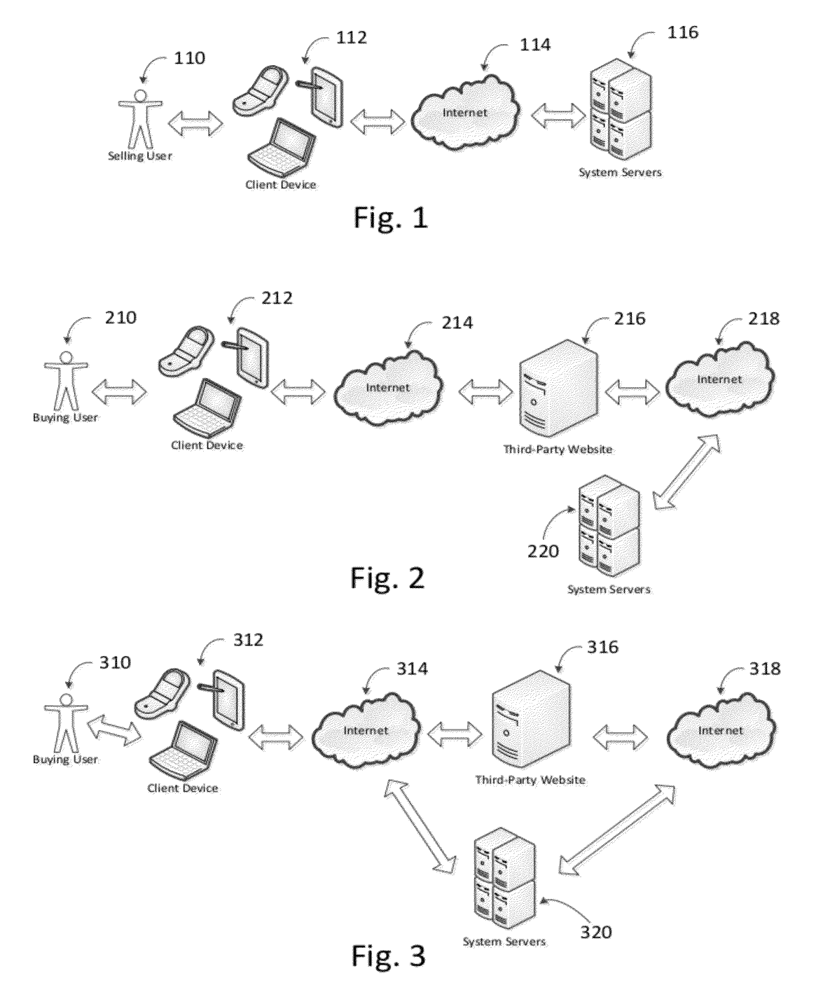

FIG. 1 is a representative diagram of a client 112 communicating directly with system servers 116 across the Internet 114. Each selling User 110 can have a communicative interface to the one or more servers 116 to participate in the collaborative process. This interface can be implemented on multiple types of devices (e.g. PC, mobile, tablet, etc.) through multiple methods (e.g. PC application, web page, mobile or tablet app, etc.). The one or more servers 116 will therefore, in one embodiment, provide the operative interfaces to the selling Users 110 across the Internet 114 such that they can participate. It should thus be seen that the present system and method can be implemented, in one embodiment, by one or more system 116 servers that are operably connected to the Internet 114 or other network.

With reference to FIG. 2, in a further embodiment, the one or more servers 220 can provide a buying interface or portal on the Internet 214, 218 through which a buying User 210, e.g. purchasers of the goods or services, can purchase the goods or services. The one or more servers 220 can include the ability to complete the full purchase transaction, or can parse out or control other devices and systems that effect the purchase transaction.

In this illustrated example, the servers 220 will communicate to the client devices 212 through a third-party website 216, e.g. one or more other computer devices that host a selling website, and not interact directly with the client devices 212. In such manner, the third party website 216 can have the benefit of the present system for allowing sales by a collective group of entities without having to be concerning with payment for all of the entities, as will be more full explained herein.

FIG. 3 describes another embodiment in which a third party website 316 will pass the information sent from the client devices 312 of buying Users 310 across the Internet 314 to the hosting system servers 320 across the Internet 318, and the System servers 320 then will directly communicate with the client devices 312 for the payment transaction. In such manner, the actual payment is made to the System servers 320, and not the third party website 316.

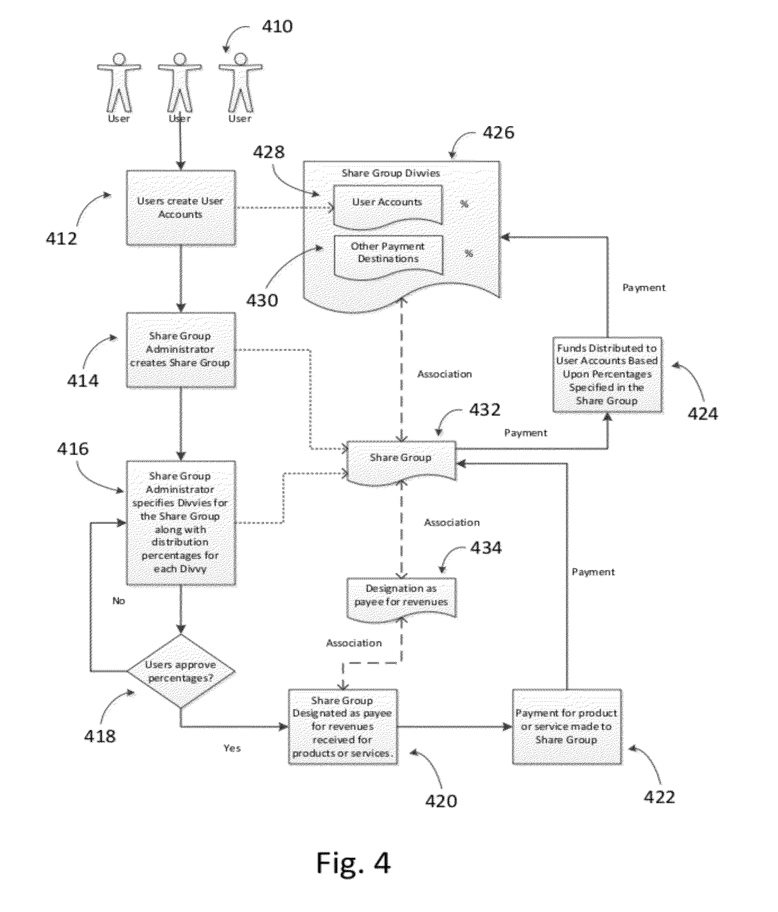

With reference to FIG. 4, illustrated is a flow diagram of one embodiment of general system operation. In general, each User 410 creates an account that contains their individual payment information (each a “User Account”), as shown at step 412. One User 410 will be the “Share Group Administrator” and create a new Share Group 432, as shown at step 414 whose revenues are to be shared with the Share Group Divvies 426. Here, the Share Group Divvies are designated as two or more User Accounts 428 and/or other payment destinations 430. These other payment destinations can be, among other things, Share Groups and direct payment destinations such as ACH payment destinations specified by the Share Group Administrator or payment destinations specified elsewhere in the System (e.g. pre-registered charities, etc.). The Share Group Administrator will then allocate the payment distribution on a percentage basis between each of the Divvies specified for the Share Groups, as shown at step 416.

Users 410 whose User Accounts are a Divvy for a Share Group 432 then approve the payment distribution percentages prior to the Share Group 432 being available to receive payments, as shown at decision 418. It should be noted that this is not a required step, but merely a design preference. The Share Group 432 is designated as the payee for payments received for products and services, as shown at step 420, noting the designation of the Share Group 432 as payee, shown at block 434, and payments are then made to the Share Group 432, as shown at step 422. Payments received by the Share Group 432 are distributed to Share Group's Divvies (e.g. the User Accounts 428 and other payment destinations 430) pursuant to the percentages specified for the Share Group 432, as shown at step 424.

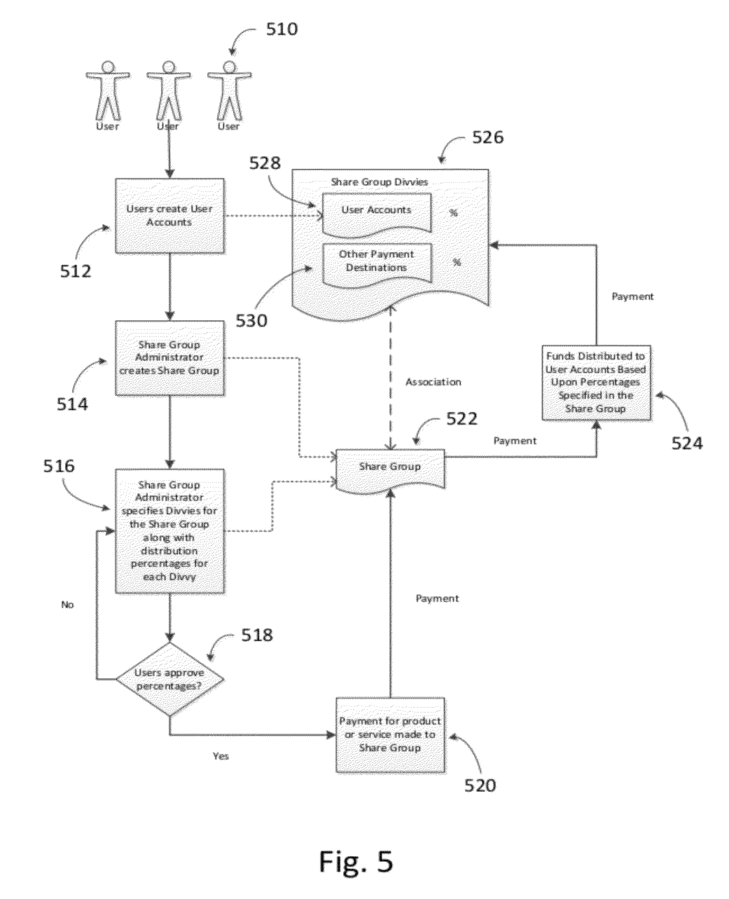

FIG. 5 illustrates a flow diagram of an alternative embodiment of system operation, in which each User 510 creates a User Account that contains their individual payment information, as shown at step 512, with one User, who is the Share Group Administrator, creating a new Share Group 522, as shown at step 514 whose revenues are to be shared between two or more Share Group Divvies 526 which can be User Accounts 528 and/or other payment destinations 530. These other payment destinations can be, among other things, Share Groups 522 and direct payment destinations such ACH payment destinations specified by the Share Group Administrator or payment destinations specified elsewhere in the System (e.g. charities, etc.). The Share Group Administrator will then allocate the payment distribution on a percentage basis between each of the Divvies specified for the Share Groups, as shown at step 516.

Users 510 whose User Accounts are a Divvy for a Share Group 522 then approve the payment distribution percentages prior to the Share Group being available to receive payments, as shown at decision 518. It should be noted that this is not a required step, but merely a design preference. Payments are then made to the Share Group 522, as shown at step 520. Payments received by the Share Group 522 are distributed to the User Accounts and other payment destinations pursuant to the percentages specified for the Share Group 522, as shown at step 524. It should also be appreciated that Share Groups may also be specified as Divvies for other Share Groups. The Share Group specified as the Divvy may have, but does not have to, the same Share Group Administrator or owner as the Share Group to which it is a member.

Share Groups can be administered through a variety of mechanisms. For example, the first is through the use of a democratic process where all Divvies of a Share Group 522 that have User Accounts and the must approve any modifications by the Share Group Administrator to the Share Group's Divvies, Divvy percentages, Hold Back amounts, Priority Divvies (e.g. payment in a certain sequence) or Priority Divvy amounts before these modifications are effective with respect to the Share Group 522. In addition, as an optional implementation, any Divvy of a Share Group 522 that has a User Account 528 may directly propose any of the foregoing modifications to the Share Group 522 with any such proposal becoming effective upon the Share Group 522 when approved by all Divvies of a Share Group that have User Accounts and the Share Group Administrator.

Alternately, an autocratic process can be used where the Share Group Administrator can modify the Share Group's Divvies 526, Divvy percentages, Hold Back amounts, Priority Divvies or Priority Divvy amounts at any time without any additional approvals being required. However, as an optional implementation, all Divvies of the Share Group 522 that have User Accounts can receive notice through the System of all modifications made by the Share Group Administrator.

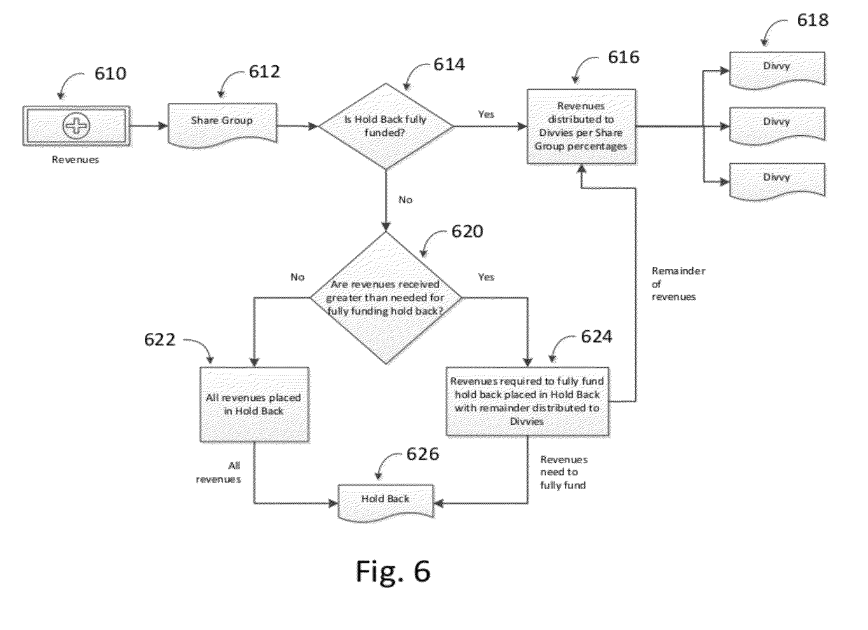

With reference to FIG. 6, a flow diagram of one embodiment of a Hold-Back implemented in the System is illustrated. A Hold-Back is a fixed amount (i.e. versus a percentage) specified for a Share Group 612 that is essentially revenues 610 held in escrow by the System and used for the payment of chargebacks, refunds and other returns of revenues previously paid to a Share Group 612. To the extent that funds are available in a Hold-Back, the need to obtain funds for the payment of chargebacks, refunds and other returns of revenues previously paid to a Share Group 612 from individual Divvies is eliminated. In one embodiment, a determination is made as to whether the Hold-Back is fully funded prior to any distributions being made to Divvies of revenues 610 received by a Share Group 612, as shown at decision 614. If there are sufficient funds, the revenues are distributed to the Divvies per Share Group percentages, as shown at step 616, and the Divvies 618 are paid.

Otherwise, if the Hold-Back is not fully funded at decision 614, then a determination is made as to whether the revenues received are greater than the Hold-Back, as shown at decision 620. If the revenues 610 are not greater (i.e. lesser) at decision 620, all revenues 622 are placed in Hold-Back 626, as shown at step 622. Otherwise if the revenue received is greater than the Hold-Back at decision 620, the appropriate amount is placed into Hold-Back to completely fund the Hold-Back to its specified amount, as shown at step 624, and the remainder is sent for payment to the Share Group's Divvies at step 616. If funds are removed from the Hold-Back by the System (i.e. to pay a chargeback, refund, etc.), then future revenues received by the Share Group 612 are again used to fund the Hold-Back to its specified amount before to any distributions of revenues received by a Share Group 612 are made to the Share Group's Divvies 618.

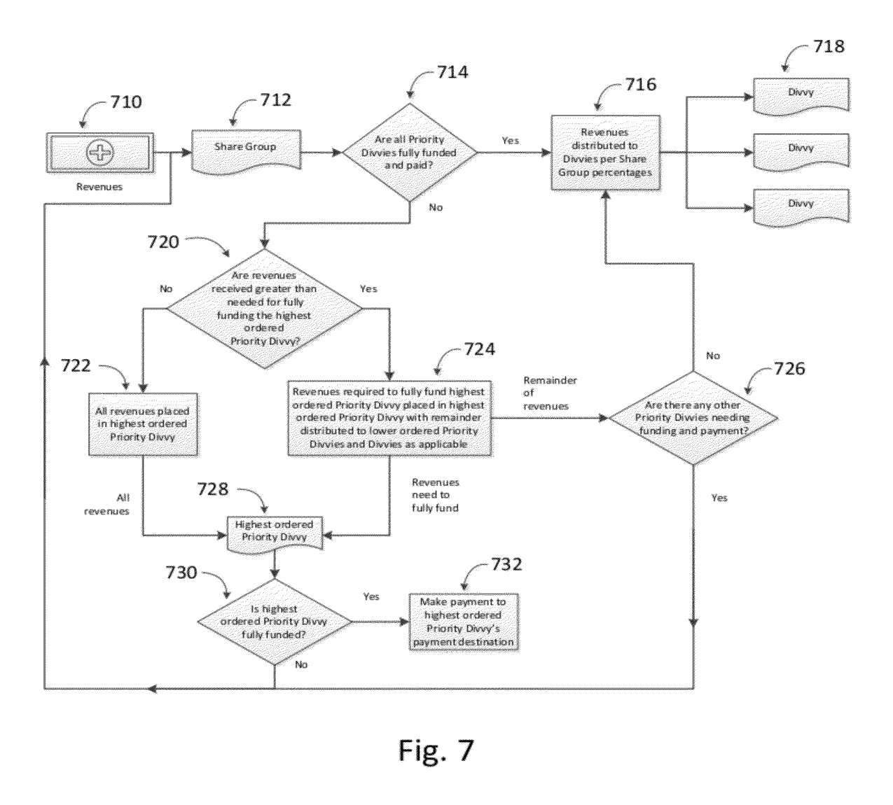

FIG. 7 is a flow diagram of one embodiment of a Priority Divvy implemented in the System. A Priority Divvy is a fixed amount (i.e. versus a percentage) specified for a Share Group 712 that is essentially funded and paid prior to any distributions of revenues received by a Share Group 712 to the Share Group's Divvies 718. A Share Group 712 can have multiple Priority Divvies which are funded and paid in a sequential order (i.e. highest ordered Priority Divvy is fully funded and paid first) specified for the Priority Divvies. A Priority Divvy can be funded and paid on a one time basis, for each receipt of revenues by the Share Group, on a periodic basis (e.g. weekly, monthly, etc.) or pursuant to other criteria. The payment destination for a Priority Divvy can be, among other things, a User Account, another Share Group, direct ACH payment destinations, payment destinations specified elsewhere in the System (e.g. charities, etc.) or payment destinations associated with an external system such as a bank's bill pay system.

Thus, as revenues 710 are received by a Share Group 712, a determination is then made as to whether all Priority Divvies are fully funded and paid, as shown at decision 714. If all Priority Divvies are fully funded and paid at decision 714, then the revenues are distributed to the Divvies 718 per the appropriate percentages, as shown at step 716. If the Priority Divvies are not fully funded at decision 714, then a decision is made as to whether the received revenues are greater than the need for funding the highest ordered Priority Divvy 728, as shown at decision 720. If yes at decision 720, then revenues required to fully fund the highest ordered Priority Divvy 728, then the Priority Divvy is fully funded as shown step 724, with the remainder of funds examined to determine if any other Priority Divvies need funding, as shown at decision 726. If no other Priority Divvies requiring funding are present at decision 726, then the remaining revenues are distributed to the Divvies 718, as shown at step 716. If there are other Priority Divvies pending at decision 726, then the process iterates to await further revenues for the Share Group 712.

Otherwise, if not enough revenue is received to fully fund the highest ordered Priority Divvy at decision 720, then all revenue is placed in the highest ordered Priority Divvy 728, as shown at step 722, or after funding the highest ordered Priority Divvy at step 724, a determination is made as to whether the highest ordered Priority Divvy is fully funded, as shown at decision 730. If the highest ordered Priority Divvy is fully funded at decision 730, then a payment is made to that Priority Divvy's payment destination, as shown at step 732. Otherwise, if not yet funded, the process iterates to await further revenue.

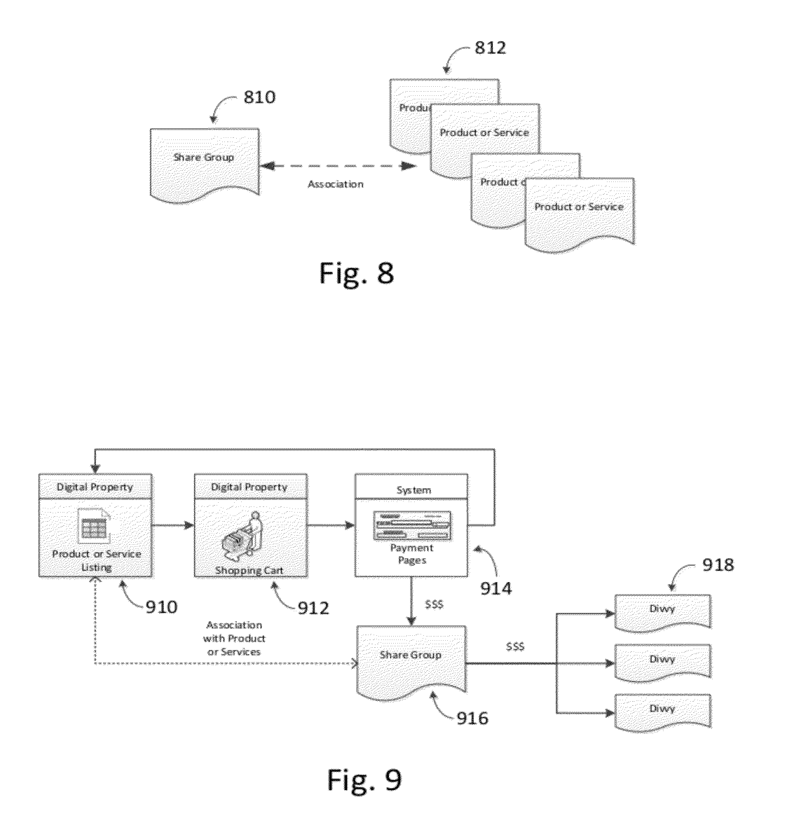

FIG. 8 is a representative diagram of the association of a Share Group 810 to one or more products or services 812. This embodiment of the System is implemented within a full function, online marketplace where Users can sell products and services directly through the marketplace. The marketplace can provide, among other things, full catalog and shopping cart functionality. Under this implementation, a Share Group can be associated with a seller's entire inventory of products and services or with specific products and services. In addition, a Seller can associate different Share Groups with different items in their inventory. The marketplace will serve as the merchant of record for all payments received for goods and services sold through the marketplace and then distribute all revenues to the appropriate Divvies pursuant to the percentages specified for the Share Group associated with the applicable good and services.

An alternative implementation of the Marketplace is to have the specification of the payment distribution between individual User Accounts be made directly for each individual product and service offered instead of having this specification associated with a Share Group that is then associated with each product and service offered. This eliminates the need for the creation of a separate Share Group. However, without the Share Group, the allocation percentages between User Accounts must be made for each product and service.

FIG. 9 is a block diagram of one embodiment of a system acting as a payment processor for a Digital Property 910. This embodiment of the System is implemented as a third-party payment processor 914 that is accessed through an API or shopping cart mechanism that can be incorporated directly into Digital Properties 910 as an external payment system. Under this implementation, the Digital Property 910 provides the catalog and shopping cart functionality and then transfers the shopping cart information 912 to the System upon checkout for payment processing. As part of a seller's account on a Digital Property 910, the seller specifies the Share Group 916 to which payment is to be made.

When a buyer selects their goods and services via the Digital Property's catalog and shopping cart functionality and is ready to make payment, the Digital Property transfers the User to the System for payment processing. As part of this transfer, information is passed to the System that specifies the applicable Share Group 916 and shopping cart contents and the buyer is taken to a web page provided by the System for payment processing. After the buyer completes payment, the buyer is returned to the Digital Property and the System distributes all revenues to the appropriate Divvies 918 pursuant to the percentages specified for the Share Group 916 associated with the transaction.

FIG. 10 is a block diagram of one embodiment of the direct implementation of the flow of ACH payment transfer within the System. Under this implementation, the System is set-up so that it is ACH transfer compatible and each Share Group 1016 is associated with an ACH compatible routing and account number. A system payment connector 1014 (or a “Share Group Account”) is then specified as the payment destination for ACH compatible payment system 1012 (e.g. a third-party payment system, a merchant account, a third-party marketplace, etc.). When payments 1010 are paid to the System payment connector 1014, the System distributes the funds to the appropriate Divvies 1018 pursuant to the percentages specified for the Share Group 1016 associated with the System payment connector 1014 receiving the funds. Implementation of the System payment connector 1014 can be through a direct implementation of ACH compatible technologies where the System receives payment directly from the ACH funds transfer system 1012 and is assigned its own ACH routing number.

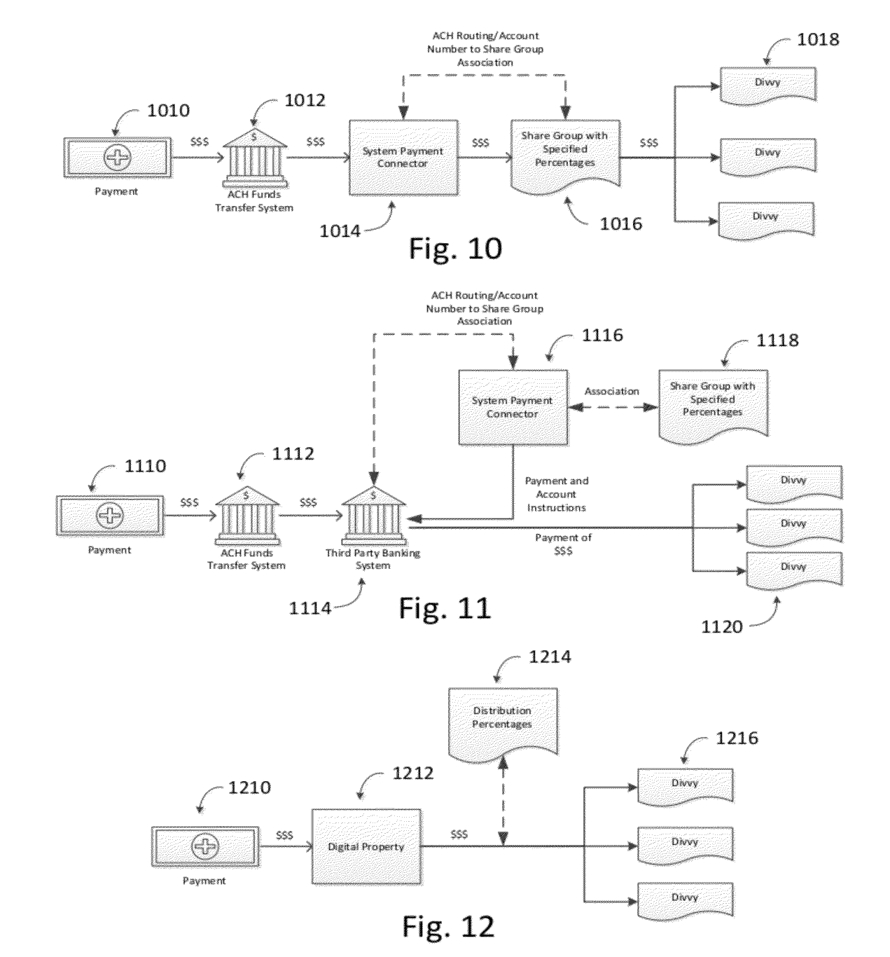

FIG. 11 is a block diagram of one embodiment of a pass-through implementation of the flow of ACH payment transfer within the System. This implementation of the System payment connector 1116 can also be made through the use of a pass-through bank account with a third-party banking system 1114 where the System has been integrated with the third-party bank's banking system 1114 and provides account management and payment instructions to the third-party banking system to direct payment to the Divvies 1120. Thus, as a payment 1110 is made to the ACH funds transfer system 1112, the third party banking system 1114 interfaces with the System payment connector 1116, which retrieves Share Group 1118 percentage information, and relays this information back to the third party banking system 1114 in the form of payment instructions, such that the Divvies 1120 can be individually paid out. In such embodiment, the third party banking system 1114 would not need to have any knowledge of the Share Group 1118.

In the implementations of FIGS. 10 and 11, a separate account number is assigned to each payment system connector 1014, 1116 and only one payment system connector 1014, 1116 is associated with a Share Group 1016, 1118. Thus, the payment ultimately to the Divvies 1018, 1120 can be completely transparent to the buyer and/or the banks making the money transfers.

FIG. 12 is a block diagram of one embodiment of the System implemented within a Digital Property 1212 without a Share Group. Under this implementation, the System is embodied as part of a Digital Property's 1212 internal functionality. Because it is part of the Digital Property's internal functionality, there is no need to create a Share Group as User Accounts are the same as the Digital Property's 1212 own User accounts and the specification of the payment distribution on a percentage basis between individual User Accounts is made directly for each individual revenues source within the Digital Property. Thus the distribution percentages 1214 are known to the Digital Property 1212 such that the Divvies 1216 can be directed by the Digital Property 1212.

The Digital Property 1212 is thus the entity selling the product and service to the end User and then it distributes payment 1210 to the applicable User accounts (Divvies 1216) for specified revenue flows within the Digital Property 1212 based upon the specified distribution percentage. For example, a Digital Property 1212 that offers a specific set of services, but has different providers of the service within the Digital Property 1212 can use the System without Share Groups to allow these providers to specify how the revenues received for each service are distributed to multiple User Accounts.

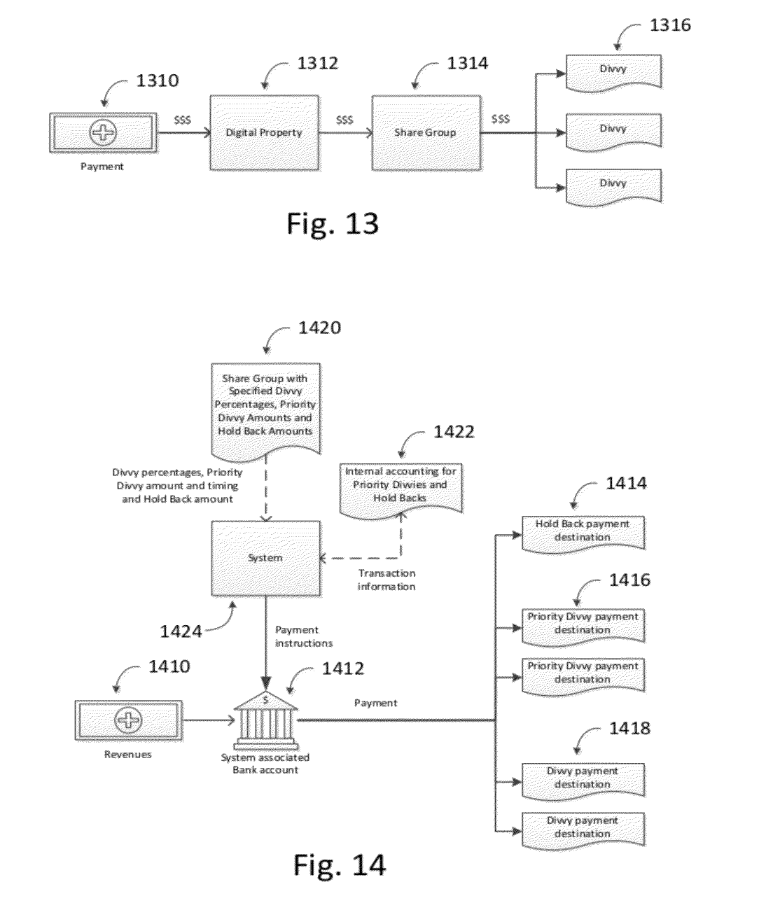

FIG. 13 is a block diagram of one embodiment of the System implemented within a Digital Property 1312 with a Share Group 1314. This can be an alternative embodiment to that shown in FIG. 12, with this implementation used where Share Groups are integrated and used with the Digital Property's internal functionality as shown in FIG. 13. Here, upon a payment 1310 being made by a buyer purchasing a product or service through the Digital Property 1312, the Digital Property 1310 uses the Share Group 1314 to effect payment to the Divvies 1316 through any of the other disclosed embodiments.

FIG. 14 is a block diagram of one embodiment of the System having direct implementation of both Hold-Backs and Priority Divvies. Under this implementation, all revenues 1410 received by all Share Groups are held in a single bank account 1412 managed by the System 1424 and the System 1424 calculates and maintains balances for all Share Groups 1420 having Hold-Backs 1414 and Priority Divvies 1416. The System 1424 then does the internal accounting 1422 for the Hold-Backs and Divvies makes all required payments to specified payment destinations from this single bank account 1412 by providing payment instructions to the applicable bank for the bank account. These payment instructions can be, among other things, ACH instructions, checks, e-checks, or other direct payment instructions made through integration with the bank's banking systems. Payments to Divvy payment destinations 1418 can likewise be made in conjunction with payments to the Priority-Divvy payment destinations 1416 and the Hold-Back payment destination 1414.

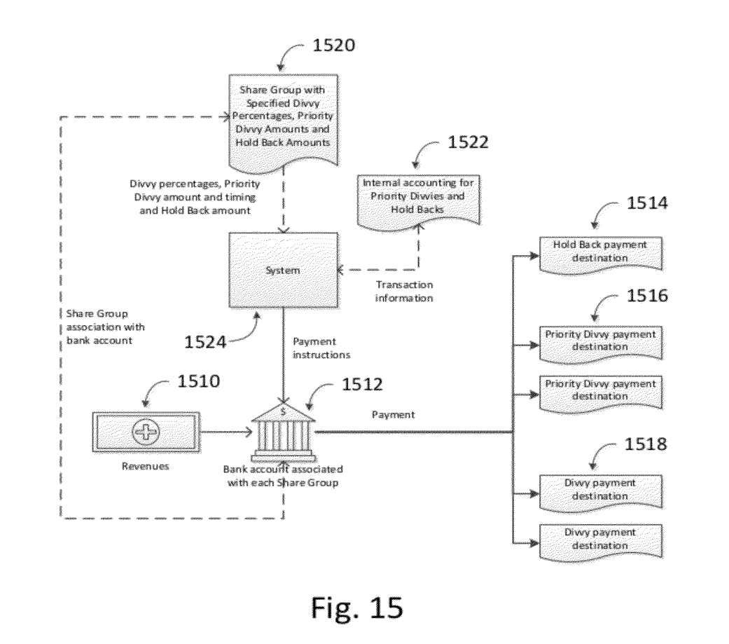

FIG. 15 is a block diagram of one embodiment of the System having pass-through implementation of Hold-Backs and Priority Divvies with a Share Group-associated bank account 1512. Under this implementation, all revenues received by a Share Groups are held in a bank account dedicated to the Share Group. The System 1524 calculates and maintains balances for all Share Groups 1520 having Hold-Backs and Priority Divvies 1420 within the System 1424 (internal accounting 1522). The System 1424 then makes all required payments related to the Share Group Divvy payment destinations 1518, Priority Divvy payment destinations 1516 and Hold-Back payment destination 1514 from the bank account 1512 associated with the Share Group. These payment instructions can be, among other things, ACH instructions, checks, e-checks, or other direct payment instructions made through integration with the bank's banking systems. As an alternative implementation, separate bank accounts could be associated with the Share Group's Hold-Back and each of its Priority Divvies with the System 1524 making transfer instructions between the Share Group's associated bank account and the Hold-Back and Priority Divvy associated bank accounts and making payments directly from these individual accounts to the payment destinations for the Hold-Back and Priority Divvies as applicable.

It should be appreciated that certain changes can be made in the form and arrangement of the elements described herein without departing from the scope of this disclosure that is described in the Claims. Furthermore, there can greater or lesser individual elements engaged in the processes described herein, with such elements engaging in more or less functionality than is described herein.

What is claimed is:

1. A system for facilitating the distribution of revenue across a network to a collective group of entities, comprising at least one computer system that is accessible by at least one of a plurality of recipients across a network, the at least one computer system further configured to provide a share group interface that is displayable to the at least one of a plurality of recipients wherein the at least one recipient selectively designates a plurality of payment destinations for the plurality of recipients wherein the payments destinations are assigned a predetermined payment divvy from payments made to the plurality of recipients, and the at least one computer system further configured to direct payments to the plurality of payment destinations based upon the predetermined payment divvy upon funds being received that are to be divvied between the plurality of recipients.

2. The system of claim 1, wherein the computer system further configured to send data to provide the recipient interface to a client computer for at least one of the plurality of recipients.

3. The system of claim 1, wherein the predetermined payment divvy includes a specific amount held-back from payment to the plurality of recipients.

4. The system of claim 1, wherein the predetermined payment divvy includes one or more priority payments to at least one of the plurality of recipients.

5. The system of claim 1, wherein the predetermined payment divvy includes a payment to a third party that is not within the plurality of recipients.

6. The system of claim 1, wherein the computer system is further configured to create a share group account that receives payment to be divvied between the plurality of recipients.

7. The system of claim 1, wherein the computer system is further configured to receive a share group account from the at least one of a plurality of recipients, the share group account receiving payment to be divvied between the plurality of recipients.

8. The system of claim 1, wherein the computer system is further configured to designate a payment mechanism interface as a share group account, the share group account receiving payment to be divvied between the plurality of recipients.

9. The system of claim 8, wherein the computer system further configured to send payment instructions to payment mechanism interface to cause one or more payment divvies to be paid to the payment destinations.

10. A system for facilitating the distribution of revenue across a network to a collective group of entities, comprising:
means for providing a recipient interface that is displayable across a network to at least one of a plurality of recipients, wherein the means for providing a recipient interface further allowing the at least one recipient to designate a plurality of payment destinations for the plurality of sellers wherein the payments destinations are assigned a predetermined payment divvy from payments made to the plurality of recipients; and
means for directing payments to the plurality of payment destinations based upon the predetermined payment divvy upon funds being received that are to be divvied between the plurality of recipients.

11. A method for facilitating the distribution of revenue across a network to a collective group of entities, comprising:
providing a recipient interface that is displayable across a network to at least one of a plurality of recipients;
receiving instructions from the at least one recipient to designate a plurality of payment destinations for the plurality of recipients wherein the payment destinations are assigned a predetermined payment divvy from payments made to the plurality of recipients; and
upon funds being received for payment to the plurality of recipients, directing payments to the plurality of payment destinations based upon the predetermined payment divvy.

12. The method of claim 11, wherein directing payments to the plurality of payment destinations includes holding back a specific amount from payment to the plurality of recipients.

13. The method of claim 11, wherein directing payments to the plurality of payment destinations includes one or more priority payments to at least one of the plurality of recipients.

14. The method of claim 11, wherein directing payments to the plurality of payment destinations includes paying a third party that is not within the plurality of recipients.

15. The method of claim 11, further comprising creating a share group account that receives payment to be divvied between the plurality of recipients.

16. The method of claim 11, further comprising receiving the share group account data from the at least one of a plurality of recipients, the share group account receiving payment to be divvied between the plurality of recipients.

17. The method of claim 11, further comprising designating a payment mechanism interface as the share group account, the share group account receiving payment to be divvied between the plurality of recipients.

18. The method of claim 17, wherein directing payments to the plurality of payment destinations comprises sending payment instructions to a financial system to cause one or more payment divvies to be paid to the plurality of recipients.

19. A method for facilitating the distribution of revenue across a network to a collective group of entities, comprising:
a step for providing a recipient interface that is displayable across a network to at least one of a plurality of recipients;
a step for receiving instructions from the at least one recipient to designate a plurality of payment destinations for the plurality of sellers wherein the payment destinations are assigned a predetermined payment divvy from payments made to the plurality of recipients; and
a step for, upon funds being received for payment to the plurality of recipients, directing payments to the plurality of payment destinations based upon the predetermined payment divvy.

20. A computer readable storage medium containing instructions that, when executed by one or more computers, causes the one or more computers to facilitate the distribution of revenue across a network to a collective group of entities through the steps of:
providing a recipient interface that is displayable across a network to at least one of a plurality of recipients;
receiving instructions from the at least one recipient to designate a plurality of payment recipients for the plurality of sellers wherein the payment destinations are assigned a predetermined payment divvy from payments made to the plurality of recipients; and
upon funds being received for payment to the plurality of recipients, directing payments to the plurality of payment destinations based upon the predetermined payment divvy.
